(19) United States
(12) Patent Application Publication
(10) Pub. No.: US 2026/0184573 A1
(43) Pub. Date: Jul. 2, 2026

(54) GRAPHENE COMPOSITE CONDUCTIVE MATERIAL AND PREPARATION METHOD THEREOF

(71) Applicant: Hengfei Li, Haikou (CN)

(72) Inventor: Hengfei Li, Haikou (CN)

(21) Appl. No.: 19/028,497

(22) Filed: Jan. 17, 2025

(30) Foreign Application Priority Data
Dec. 27, 2024 (CN) 2024119512838

(51) Int. Cl. C01B 32/194

(52) U.S. Cl. CPC C01B 32/194; C01P 2004/61; C01P 2006/40

(57) ABSTRACT

A graphene composite conductive material and a preparation method thereof, the graphene composite conductive material is prepared from the following raw materials in parts by weight: 12-25 parts of MnO₂/graphene composite material, 15-25 parts of graphite powder, 35-50 parts of polymer resin, 1-8 parts of filler. By utilizing the large specific surface area of graphene, it enhances electron migration efficiency; not only does this facilitate the uniform growth of MnO₂ particles on the graphene sheets, but the uniform loading of MnO₂ also prevents the aggregation and stacking of graphene sheets during the composite process; graphite powder and graphene layer form an effective conductive path; the functional groups on the surface of graphene and MnO₂ can chemically bond with the polymer resin molecular chains to enhance the interfacial interaction; the filler, with high strength and modulus, serves as reinforcing phases to enhance mechanical properties of the graphene composite conductive material.

### 1. TECHNICAL FIELD

The invention relates to the technical field of conductive materials, in particular to a graphene composite conductive material and a preparation method thereof.

### 2. BACKGROUND ART

Graphene, as a two-dimensional carbon material, is regarded as an ideal conductive filler due to its unique two-dimensional structure and excellent physicochemical properties, such as extremely high electrical conductivity, large specific surface area, good mechanical strength, and chemical stability. The carbon hexagonal ring of flawless monolayer graphene is nearly perfect, and it is difficult to alter its structure under the bonding of each carbon atom, macroscopically exhibiting extremely high tensile and compressive strengths. Graphene also possesses excellent electrical conductivity, as each carbon atom in the monolayer graphene structure contributes an unbonded electron. These electrons can freely move within the crystal, macroscopically manifesting good electrical conductivity. Furthermore, graphene exhibits superior thermal conductivity. Due to the absence of crystalline defects and its highly stable two-dimensional crystal structure, these characteristics contribute to its excellent thermal conduction.

However, pure graphene materials face problems such as poor dispersion and difficulty in processing in practical applications. Therefore, in order to overcome the limitations of single materials, researchers have begun to explore the composite of graphene with other materials to create composite conductive materials with excellent overall performance. These composite materials can combine the high electrical conductivity of graphene with the mechanical properties, thermal stability, and other advantages of other materials. However, existing graphene composite conductive materials still have the following shortcomings in terms of electrical conductivity, mechanical properties, and processability: limited improvement in conductivity, making them insufficient for high-conductivity applications; inadequate mechanical properties, especially in the field of flexible conductive materials; complex preparation processes that make large-scale production challenging; and high material costs, which limit their widespread application in certain fields. Therefore, there is an urgent need to develop a graphene composite conductive material with both good electrical conductivity and high mechanical properties.

### 3. SUMMARY OF THE INVENTION

In view of the shortcomings of existing technologies, the invention provides a graphene composite conductive material and a preparation method thereof. The invention uses a combination of MnO₂/graphene composite material, graphite powder, polyimide, and filler in the design. The graphene composite conductive material is prepared by using the MnO₂/graphene composite material and other components; graphite powder serves as part of the conductive network, forming an effective conductive path with the graphene layers in the MnO₂/graphene composite material. MnO₂ can interact with the defect sites on the graphene, enhancing the overall electrochemical performance of the material. Polyimide, as the matrix material, provides mechanical strength and thermal stability, while fixing the graphene and MnO₂ particles, thus improving the stability of the graphene composite conductive material. The filler, with high strength and modulus, serves as reinforcing phases to enhance the mechanical properties of the graphene composite conductive material; the conductive property of the filler forms a three-dimensional conductive network with the graphene and graphite powder, further improving the overall conductivity. The graphene composite conductive material prepared by the invention has good environmental stability, can maintain its performance under various environmental conditions, and is easy to process and recycle.

In order to realize the above technical objects, the technical scheme adopted by the invention is as follows:

the invention provides a graphene composite conductive material, wherein the graphene composite conductive material is prepared from the following raw materials in parts by weight: 12-25 parts of MnO₂/graphene composite material, 15-25 parts of graphite powder, 35-50 parts of polymer resin, 1-8 parts of filler, and 1-3 parts of coupling agent.

Preferably, the fineness of the graphite powder is 500-2000 mesh.

Preferably, the polymer resin is at least one of polyimide and LCP (liquid crystal polymer).

Preferably, the filler is at least one of carbon fiber mesh, copper mesh and nickel mesh.

Preferably, the coupling agent is at least one of KH-550 (γ-Aminopropyl triethoxysilane), A151 (γ-chloropropylmethyldiethoxysilane) and KH-570 (Triethoxyvinylsilane).

Preferably, preparation materials for the MnO₂/graphene composite material are graphene and MnO₂.

A preparation method of the MnO₂/graphene composite material specifically comprises the following steps:
(1) ultrasonically dispersing graphene in anhydrous ethanol for 1-2 h; the usage ratio of graphene to anhydrous ethanol is 1 g:35 mL; forming a dispersion, adding MnO₂ to the dispersion, performing magnetic stirring to form a homogeneous reaction mixture;
(2) transferring the reaction mixture obtained in step (1) into a Teflon-lined stainless steel autoclave for hydrothermal reaction, setting the temperature at 200° C., and the time for 24 h; after cooling to room temperature, washing and centrifuging the mixture, then drying it in an oven to obtain the MnO₂/graphene composite material.

Further, the mass ratio of MnO₂ to the dispersion is 2-5:19.

The invention also provides a preparation method of the graphene composite conductive material, specifically comprising the following steps:
S1: weighing the graphite powder in parts by weight and ultrasonically dispersing it in deionized water for 1 h; the mass ratio of graphite powder to deionized water is 1:20; forming a suspension, adding the polymer resin and coupling agent to the suspension according to parts by weight, and then stirring at 1000 rpm for 30 min to obtain mixture A;
S2: weighing the MnO₂/graphene composite material in parts by weight and adding it to DMF (N,N-Dimethylformamide), ultrasonically dispersing for 30-60 min to form mixture B, adding the mixture A obtained in S1 to the mixture B, and stirring at a constant temperature to obtain mixture C;
S3: weighing the filler in parts by weight, immersing the mixture C obtained in S2 onto the filler by using an impregnation method, controlling the time to be 10-20 min, the pressure to be 0.1-0.5 MPa, the temperature to be 50° C.; after infiltration, drying it at room temperature to form a reaction precursor; the reaction precursor is loaded into a molding mold, and performing thermal molding on a high-temperature mechanical pressure vulcanizer to obtain the graphene composite conductive material.

Further, the usage ratio of the MnO₂/graphene composite material to DMF is 1 g:20-30 mL.

Further, the thermal molding process involving heating the mold from room temperature to 200° C. at a rate of 10° C./min, then maintaining the temperature and pressure at 20 MPa for 10 minutes, with multiple depressurization and venting cycles during the process; increasing the temperature to 300° C., and maintaining the temperature and pressure for 40 minutes; after the temperature and pressure holding is completed, the mold is cooled to room temperature and demolded; the sample is then placed in an oven and heated freely to 200° C., held for 60 minutes, then heated to 220° C. and held for 120 minutes; finally, the oven is cooled to room temperature, and then the sample can be taken out.

Further, the model of the high-temperature mechanical pressure vulcanizer is OLLHY-50T.

Compared with the prior art, the invention has the following advantageous effects:
the graphene composite conductive material prepared by the invention uses a combination of MnO₂/graphene composite material, graphite powder, polymer resin, and filler in the design. The graphene composite conductive material is prepared by using the MnO₂/graphene composite material and other components; the prepared graphene composite conductive material has good electrochemical performance and good mechanical properties; graphite powder serves as part of the conductive network, forming an effective conductive path with the graphene layers in the MnO₂/graphene composite material; MnO₂ can interact with the defect sites on the graphene, enhancing the overall electrochemical performance of the material; the functional groups on the surface of graphene and MnO₂ can chemically bond with the polymer resin molecular chains to enhance the interfacial interaction; polyimide, as the matrix material, provides mechanical strength and thermal stability, while fixing the graphene and MnO₂ particles, thus improving the stability of the graphene composite conductive material; the filler, with high strength and modulus, serves as reinforcing phases to enhance the mechanical properties of the graphene composite conductive material; the conductive property of the filler forms a three-dimensional conductive network with the graphene and graphite powder, further improving the overall conductivity the MnO₂/graphene composite material effectively preserves the characteristics of both MnO₂ and graphene sheets; by utilizing the large specific surface area of graphene, it enhances electron migration efficiency; not only does this facilitate the uniform growth of MnO₂ particles on the graphene sheets, but the uniform loading of MnO₂ also prevents the aggregation and stacking of graphene sheets during the composite process, indirectly increasing the active sites for Mn²⁺ on the graphene sheets; at the same time, the interconnected graphene sheets form a conductive network, giving the composite material excellent electrical conductivity; the large specific surface area of graphene and its sheet-like structure serve as the framework for the MnO₂/graphene composite material, supporting MnO₂ and enabling rapid transfer of Photo-electrons, reducing the recombination efficiency of electron holes, thereby improving the dispersion and conductivity of MnO₂; the two-dimensional layered structure of graphene provides support to MnO₂, preventing volume expansion and structural collapse during electrochemical reactions, which enhances the material's cycling stability and service life; graphene's extremely high specific surface area allows it to load more MnO₂, providing additional active sites and thus improving the overall performance of the composite conductive material; the conductive network formed by graphene facilitates the rapid transfer of electrons between MnO₂ particles, reducing charge transport resistance and increasing the reaction efficiency of the electrode material; graphene acts as a carrier, aiding in the uniform dispersion of MnO₂ particles and preventing aggregation, thereby enhancing the utilization and performance of the composite conductive material; the combination of graphene and MnO₂ improves the material's performance at high temperatures; the added polymer resin itself possesses excellent thermal stability, further enhancing the stability of the composite conductive material; and through the interactions between materials, the interface performance can be optimized, internal stress can be reduced, and the detachment and agglomeration of the conductive fillers can be prevented; the graphene composite conductive material has good environmental stability, can maintain its performance under various environmental conditions, and is easy to process and recycle. The graphene composite conductive material provided by the invention exhibits excellent electrochemical performance, features a straightforward synthesis process, and is simple in the preparation method, cost-effective, and environmentally friendly; the resultant graphene composite conductive material boasts strong conductivity, high mechanical strength, and good stability; this graphene composite conductive material can be utilized not only in energy storage, but also in various fields such as catalysis, sensors, electromagnetic shielding, demonstrating broad application potential.

### 4. BRIEF DESCRIPTION OF ACCOMPANY DRAWINGS

FIG. 1 shows a schematic diagram of the electrical conductivity of the graphene composite conductive materials of Embodiment 1 and Comparative Examples 1-3 of the invention.

FIG. 2 shows a schematic diagram of the stability of the graphene composite conductive materials of Embodiment 1 and Comparative Examples 1-3 of the invention.

FIG. 3 shows a schematic diagram of thermal conductivity of the graphene composite conductive materials of Embodiment 1 and Comparative Examples 1-3 of the invention.

### 5. SPECIFIC EMBODIMENT OF THE INVENTION

In order to enable the technical personnel in this art to better understand the technical scheme of the invention and make the above-mentioned features, purposes and advantages of the invention clearer and easier to understand, the invention is further described below in combination with the embodiments. The embodiments are only used to illustrate the invention and are not used to limit the scope of the invention.

It should be noted that, unless otherwise specified, the chemical reagents involved in the invention are purchased through commercial channels.

Embodiment 1: this embodiment provides a graphene composite conductive material, wherein the graphene composite conductive material is prepared from the following raw materials in parts by weight: 12 parts of MnO₂/graphene composite material, 15 parts of graphite powder, 35 parts of polyimide, 1 part of carbon fiber mesh, and 1 part of KH-550.

The fineness of the graphite powder is 2000 mesh.

Preparation materials for the MnO₂/graphene composite material are graphene and MnO₂.

A preparation method of the MnO₂/graphene composite material specifically comprises the following steps:
(1) ultrasonically dispersing graphene in anhydrous ethanol; ultrasonically dispersing in an ultrasonic cleaning machine for 1 h with the power set to 240 W; the usage ratio of graphene to anhydrous ethanol is 1 g:35 mL; forming a dispersion, adding MnO₂ to the dispersion; the mass ratio of MnO₂ to the dispersion is 2:19, performing magnetic stirring at 60° C. and 800 rpm by using a magnetic stirrer to form a homogeneous reaction mixture;
(2) transferring the reaction mixture obtained in step (1) into a Teflon-lined stainless steel autoclave for hydrothermal reaction, setting the temperature at 200° C., and the time for 24 h; after cooling to room temperature, alternately washing and centrifuging with deionized water and absolute ethanol, then drying it in an oven at 70° C. for 24 h to obtain the MnO₂/graphene composite material.

The invention also provides a preparation method of the graphene composite conductive material, specifically comprising the following steps:
S1: weighing 15 parts of graphite powder and ultrasonically dispersing it in deionized water for 1 h; the mass ratio of graphite powder to deionized water is 1:20; forming a suspension, adding 35 parts of polyimide and 1 part of KH-550 to the suspension, and then stirring at 1000 rpm for 30 min to obtain mixture A;
S2: weighing 12 parts of MnO₂/graphene composite material and adding it to DMF; the usage ratio of the MnO₂/graphene composite material to DMF is 1 g:20 mL; in an ultrasonic cleaning machine, ultrasonically dispersing for 30 min at a power setting of 240 W to form mixture B; adding the mixture A obtained in S1 to the mixture B, and stirring at 800 rpm at 60° C. to obtain mixture C;
S3: weighing 1 part of carbon fiber mesh, immersing the mixture C obtained in S2 onto the carbon fiber mesh; the carbon fiber mesh is pre-soaked and cleaned with acetone, and then dried before use; using the impregnation method to immerse, controlling the time to be 10 min, the pressure to be 0.1 MPa, the temperature to be 50° C.; after infiltration, drying it at room temperature to form a reaction precursor; the reaction precursor is loaded into a molding mold, and performing thermal molding on a high-temperature mechanical pressure vulcanizer; the thermal molding process involving heating the mold from room temperature to 200° C. at a rate of 10° C./min, then maintaining the temperature and pressure at 20 MPa for 10 minutes, with multiple depressurization and venting cycles during the process; increasing the temperature to 300° C., and maintaining the temperature and pressure for 40 minutes; after the temperature and pressure holding is completed, the mold is cooled to room temperature and demolded; the sample is then placed in an oven and heated freely to 200° C., held for 60 minutes, then heated to 220° C. and held for 120 minutes; finally, the oven is cooled to room temperature, and then the sample can be taken out, thereby obtaining the graphene composite conductive material.

Embodiment 2: this embodiment provides a graphene composite conductive material, wherein the graphene composite conductive material is prepared from the following raw materials in parts by weight: 18 parts of MnO₂/graphene composite material, 20 parts of graphite powder, 42 parts of polyimide, 5 parts of copper mesh, and 2 parts of A151.

The fineness of the graphite powder is 1000 mesh.

Preparation materials for the MnO₂/graphene composite material are graphene and MnO₂.

A preparation method of the MnO₂/graphene composite material specifically comprises the following steps:
(1) ultrasonically dispersing graphene in anhydrous ethanol; ultrasonically dispersing in an ultrasonic cleaning machine for 1 h with the power set to 240 W; the usage ratio of graphene to anhydrous ethanol is 1 g:35 mL; forming a dispersion, adding MnO₂ to the dispersion; the mass ratio of MnO₂ to the dispersion is 3:19, performing magnetic stirring at 60° C. and 800 rpm by using a magnetic stirrer to form a homogeneous reaction mixture;
(2) transferring the reaction mixture obtained in step (1) into a Teflon-lined stainless steel autoclave for hydrothermal reaction, setting the temperature at 200° C., and the time for 24 h; after cooling to room temperature, alternately washing and centrifuging with deionized water and absolute ethanol, then drying it in an oven at 70° C. for 24 h to obtain the MnO₂/graphene composite material.

The invention also provides a preparation method of the graphene composite conductive material, specifically comprising the following steps:
S1: weighing 20 parts of graphite powder and ultrasonically dispersing it in deionized water for 1 h; the mass ratio of graphite powder to deionized water is 1:20; forming a suspension, adding 42 parts of polyimide and 2 parts of A151 to the suspension, and then stirring at 1000 rpm for 30 min to obtain mixture A;
S2: weighing 18 parts of MnO₂/graphene composite material and adding it to DMF; the usage ratio of the MnO₂/graphene composite material to DMF is 1 g:25 mL; in an ultrasonic cleaning machine, ultrasonically dispersing for 45 min at a power setting of 240 W to form mixture B; adding the mixture A obtained in S1 to the mixture B, and stirring at 800 rpm at 60° C. to obtain mixture C;
S3: weighing 5 parts of copper mesh, immersing the mixture C obtained in S2 onto the copper mesh; the copper mesh is pre-soaked and cleaned with acetone, and then dried before use; using the impregnation method to immerse, controlling the time to be 15 min, the pressure to be 0.2 MPa, the temperature to be 50° C.; after infiltration, drying it at room temperature to form a reaction precursor; the reaction precursor is loaded into a molding mold, and performing thermal molding on a high-temperature mechanical pressure vulcanizer; the thermal molding process involving heating the mold from room temperature to 200° C. at a rate of 10° C./min, then maintaining the temperature and pressure at 20 MPa for 10 minutes, with multiple depressurization and venting cycles during the process; increasing the temperature to 300° C., and maintaining the temperature and pressure for 40 minutes; after the temperature and pressure holding is completed, the mold is cooled to room temperature and demolded; the sample is then placed in an oven and heated freely to 200° C., held for 60 minutes, then heated to 220° C. and held for 120 minutes; finally, the oven is cooled to room temperature, and then the sample can be taken out, thereby obtaining the graphene composite conductive material.

Embodiment 3: this embodiment provides a graphene composite conductive material, wherein the graphene composite conductive material is prepared from the following raw materials in parts by weight: 25 parts of MnO₂/graphene composite material, 25 parts of graphite powder, 50 parts of LCP, 8 parts of nickel mesh, and 3 parts of KH-570.

The fineness of the graphite powder is 500 mesh.

Preparation materials for the MnO₂/graphene composite material are graphene and MnO₂.

A preparation method of the MnO₂/graphene composite material specifically comprises the following steps:
(1) ultrasonically dispersing graphene in anhydrous ethanol; ultrasonically dispersing in an ultrasonic cleaning machine for 1 h with the power set to 240 W; the usage ratio of graphene to anhydrous ethanol is 1 g:35 mL; forming a dispersion, adding MnO₂ to the dispersion; the mass ratio of MnO₂ to the dispersion is 5:19, performing magnetic stirring at 60° C. and 800 rpm by using a magnetic stirrer to form a homogeneous reaction mixture;
(2) transferring the reaction mixture obtained in step (1) into a Teflon-lined stainless steel autoclave for hydrothermal reaction, setting the temperature at 200° C., and the time for 24 h; after cooling to room temperature, alternately washing and centrifuging with deionized water and absolute ethanol, then drying it in an oven at 70° C. for 24 h to obtain the MnO₂/graphene composite material.

The invention also provides a preparation method of the graphene composite conductive material, specifically comprising the following steps:
S1: weighing 15 parts of graphite powder and ultrasonically dispersing it in deionized water for 1 h; the mass ratio of graphite powder to deionized water is 1:20; forming a suspension, adding 50 parts of LCP and 3 parts of KH-570 to the suspension, and then stirring at 1000 rpm for 30 min to obtain mixture A;
S2: weighing 25 parts of MnO₂/graphene composite material and adding it to DMF; the usage ratio of the MnO₂/graphene composite material to DMF is 1 g:30 mL; in an ultrasonic cleaning machine, ultrasonically dispersing for 60 min at a power setting of 240 W to form mixture B; adding the mixture A obtained in S1 to the mixture B, and stirring at 800 rpm at 60° C. to obtain mixture C;
S3: weighing 8 parts of nickel mesh, immersing the mixture C obtained in S2 onto the nickel mesh; the nickel mesh is pre-soaked and cleaned with acetone, and then dried before use; using the impregnation method to immerse, controlling the time to be 20 min, the pressure to be 0.5 MPa, the temperature to be 50° C.; after infiltration, drying it at room temperature to form a reaction precursor; the reaction precursor is loaded into a molding mold, and performing thermal molding on a high-temperature mechanical pressure vulcanizer; the thermal molding process involving heating the mold from room temperature to 200° C. at a rate of 10° C./min, then maintaining the temperature and pressure at 20 MPa for 10 minutes, with multiple depressurization and venting cycles during the process; increasing the temperature to 300° C., and maintaining the temperature and pressure for 40 minutes; after the temperature and pressure holding is completed, the mold is cooled to room temperature and demolded; the sample is then placed in an oven and heated freely to 200° C., held for 60 minutes, then heated to 220° C. and held for 120 minutes; finally, the oven is cooled to room temperature, and then the sample can be taken out, thereby obtaining the graphene composite conductive material.

The difference between Comparative Example 1 and Embodiment 1 is that the addition of MnO₂ is eliminated, and the rest is the same as Embodiment 1.

The difference between Comparative Example 2 and Embodiment 1 is that the addition of polymer resin is eliminated, and the rest is the same as Embodiment 1.

The difference between Comparative Example 3 and Embodiment 1 is that the addition of filler is eliminated, and the rest is the same as Embodiment 1.

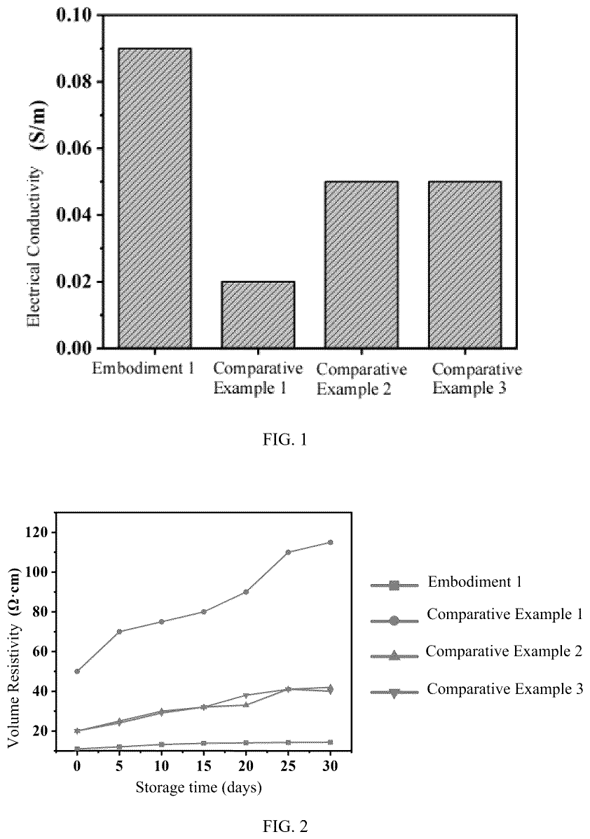

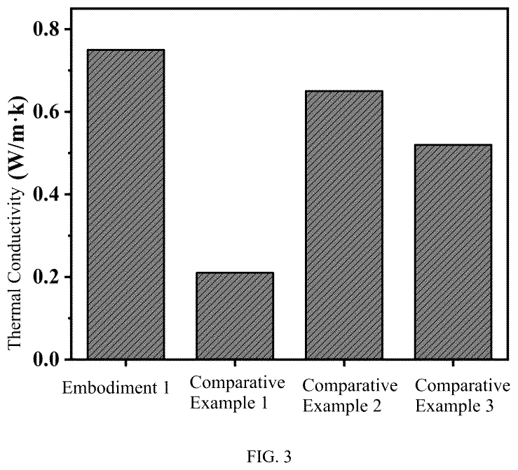

Experiment Example 1: the electrical conductivity of the samples in Embodiments 1-3 and Comparative Examples 1-3 was tested by using the TechRST-8 four-point probe resistivity tester. The thermal conductivity of the samples in Embodiments 1-3 and Comparative Examples 1-3 was tested by using the PPMS-9T physical property measurement system produced by Quantum Design, USA. Testing Principle: a thermal pulse is applied to one surface of the sample, and the heat is transferred to the opposite surface; the system collects the temperature difference within the sample and calculates the material's thermal conductivity based on the sample's geometry. The electrical conductivity results are shown in FIG. 1, and the thermal conductivity results are shown in FIG. 3.

Experimental Example 2: the tensile strength test of the graphene composite conductive material prepared in this invention was conducted according to the national standard GB/T 453-2002 “Paper and board-Determination of tensile properties.” Graphene composite conductive materials prepared from Embodiments 1-3 and Comparative Examples 1-3 were used as test specimens. A tensile strength tester was employed to measure the tensile strength of the specimens under constant speed conditions. The load of the clamps was adjusted to ensure that the specimens neither slipped nor were damaged during the test. Appropriate weights were attached to the clamps, and the weights drove the loading indicator to record readings. The test was conducted under standard atmospheric conditions for temperature and humidity treatment of the specimens. The zero position and horizontal alignment before and after of the measuring mechanism and recording device were verified. The distance between the upper and lower clamps was adjusted, and the specimens were clamped in place, with care taken to avoid touching the test area between the clamps with hands. A pre-tension of 98 mN was applied to the specimens, which were then clamped vertically between the two clamps. A preliminary test was first conducted to determine the loading rate at which the specimens broke within 20 seconds. From the start of the measurement until the specimens broke, the maximum force applied was recorded. The results obtained for the longitudinal and transverse tensile strengths of paper and board were calculated and presented separately. Tensile strength was calculated by using the formula S=F/L_{W}, wherein S is the tensile strength, the unit is kN/m, F is the average tensile force, the unit is N, L_{W} is the width of the sample, the unit is mm, the results are recorded in Table 1.

Experiment Example 3: in accordance with the GB/T 1040-92 standard, graphene composite conductive materials prepared from Embodiments 1-3 and Comparative Examples 1-3 of the invention were each made into 1 mm samples. The samples were then shaped into dumbbell-type standard test strips by using a CP-25 punching machine. Tensile tests were conducted on a computer-controlled electronic universal testing machine (WDW-20). The maximum tensile force was 500 N, with a tensile speed of 200 mm/min. The basic dimensions of the samples were 100×6×1 mm. The breaking elongation and elastic modulus were measured, and the results are recorded in Table 1.

Experimental Example 4: the graphene composite conductive materials prepared according to Embodiments 1-3 and Comparative Examples 1-3 of the invention were used as samples to test the maximum roughness of their bonded surfaces. Each sample was prepared into a material bonding surface, and a stylus-type surface roughness tester was used to conduct the test. The test samples were ensured to be clean, dry, and free of any contaminants. The maximum roughness of the bonded surface was tested in accordance with the instrument's operating specifications, and the results were recorded in Table 1.

| | | | | Maximum |
|---|---|---|---|---|
| | Tensile | Breaking | Elastic | Roughness of |
| Group | Strength | Elongation | Modulus | Bonded Surface |
| Embodiment 1 | 582 | 620 | 12.2 | 1.0 |
| Embodiment 2 | 581 | 610 | 12.1 | 0.8 |
| Embodiment 3 | 582 | 620 | 12.1 | 0.5 |
| Comparative | 368 | 410 | 8.6 | 0.9 |
| Example 1 | | | | |
| Comparative | 378 | 560 | 9.1 | 1.6 |
| Example 2 | | | | |
| Comparative | 376 | 550 | 9.5 | 1.3 |
| Example 3 | | | | |

The results in Table 1 show that the graphene composite conductive materials prepared in Embodiments 1-3 exhibited superior performance in three mechanical properties-tensile strength, breaking elongation, and elastic modulus, compared with that of the Comparative Examples. This indicates that the material combination and preparation method used in the invention effectively enhance the overall mechanical properties of the composite conductive materials. Specifically, the graphene composite conductive material prepared in Embodiment 1 not only has a significantly higher tensile strength than the Comparative Examples, meaning the material can withstand greater external forces without easily breaking; and the improvement in breaking elongation also indicates better flexibility and deformability of the material; the increase in elastic modulus reflects an enhanced ability of the material to resist deformation under stress, which helps improve its stability and durability; for the maximum roughness of the bonding surface, all Embodiments were lower than the Comparative Examples, indicating that the moderate maximum roughness of the bonded surface the embodiments strikes a balance between adhesiveness and wettability, resulting in good stability.

FIG. 1 shows the schematic diagram of the electrical conductivity of Embodiment 1 and Comparative Examples 1-3 of the invention. The electrical conductivity of Embodiment 1 is significantly higher than that of Comparative Examples 1-3, reaching 0.09 S/m, indicating that the interaction between materials enhances the conductive pathways, increases electrical conductivity, and the synergistic effect between materials boosts the electrical conductivity of the graphene composite conductive material. FIG. 2 shows the variation of volume resistivity with storage time; it can be observed that for the graphene composite conductive material prepared in Embodiment 1 of the invention, when the storage time is less than 10 days, the resistivity of the composite conductive material gradually increases; however, when the storage time exceeds 10 days, the volume resistivity of the composite conductive material tends to stabilize, basically maintaining at 10 Ω·cm, indicating good electrical conductivity stability of the composite conductive material. FIG. 3 shows the schematic diagram of thermal conductivity; it can be seen that the thermal conductivity of Embodiment 1 is significantly higher than that of the Comparative Examples, demonstrating that the graphene composite material of Embodiment 1 performs best in terms of thermal conductivity and has good heat conduction capability.

In conclusion, the graphene composite conductive material prepared in the invention not only exhibits excellent electrical conductivity, but also demonstrates outstanding mechanical properties. Both graphite powder and graphene are excellent conductive materials, and the incorporation of MnO₂ and graphene further enhances the cycling stability of the composite conductive material. The addition of these components significantly improves the conductivity of the composite material. The three-dimensional network structure of the filler facilitates electron transport, thereby further enhancing the conductivity. Moreover, the addition of the filler notably increases the composite material's tensile strength, elastic modulus, and impact resistance. The polymer resin itself possesses excellent thermal stability, and through the interactions between materials, the interface performance can be optimized, internal stress can be reduced, and the detachment and agglomeration of the conductive fillers can be prevented. Additionally, in practical applications, this material can adapt to various complex working environments and meet the stringent mechanical performance requirements in different fields. Whether in applications related to electronic devices, aerospace, transportation, or construction materials, this conductive composite material has the potential to offer superior performance solutions, thus driving technological advancements and product innovations in the related industries.

The above description is only a preferred specific implementation of the invention, but the protection scope of the invention is not limited thereto. Any technician familiar with the technical field can make equivalent replacements or changes according to the technical scheme and inventive concept of the invention within the technical scope disclosed by the invention, which should be covered by the protection scope of the invention.

1. A graphene composite conductive material, wherein the graphene composite conductive material is prepared from the following raw materials in parts by weight: 12-25 parts of MnO₂/graphene composite material, 15-25 parts of graphite powder, 35-50 parts of polymer resin, 1-8 parts of filler, and 1-3 parts of coupling agent;
preparation materials for the MnO₂/graphene composite material are graphene and MnO₂;
a preparation method of the MnO₂/graphene composite material specifically comprises the following steps:
(1) weighing graphene and ultrasonically dispersing it in anhydrous ethanol to form a dispersion, adding MnO₂ to the dispersion, performing magnetic stirring to form a homogeneous reaction mixture;
(2) subjecting the reaction mixture obtained in step (1) to a hydrothermal reaction; after cooling to room temperature, washing and centrifuging the mixture, then drying it to obtain the MnO₂/graphene composite material.

2. The graphene composite conductive material of claim 1, wherein in step (1), the usage ratio of graphene to anhydrous ethanol is 1 g:35 mL, and the mass ratio of MnO₂ to the dispersion is 2-5:19.

3. The graphene composite conductive material of claim 1, wherein in step (2), the hydrothermal reaction is carried out in a Teflon-lined stainless steel autoclave, the temperature is set at 200° C., and the time is set for 24 h.

4. The graphene composite conductive material of claim 1, wherein the fineness of the graphite powder is 500-2000 mesh.

5. The graphene composite conductive material of claim 1, wherein the polymer resin is at least one of polyimide and LCP.

6. The graphene composite conductive material of claim 1, wherein the filler is at least one of carbon fiber mesh, copper mesh and nickel mesh.

7. The graphene composite conductive material of claim 1, wherein the coupling agent is at least one of KH-550, A151 and KH-570.

8. A preparation method of the graphene composite conductive material of claim 1, specifically comprising the following steps:
S1: weighing the graphite powder in parts by weight and ultrasonically dispersing it in deionized water to form a suspension, adding the polymer resin and coupling agent to the suspension according to parts by weight, and then stirring quickly to obtain mixture A;
S2: weighing the MnO₂/graphene composite material in parts by weight and adding it to DMF, ultrasonically dispersing to form mixture B, adding the mixture A obtained in S1 to the mixture B, and stirring at a constant temperature to obtain mixture C;
S3: weighing the filler in parts by weight, immersing the mixture C obtained in S2 onto the filler by using an impregnation method, and drying it to form a reaction precursor, performing thermal molding on the reaction precursor to obtain the graphene composite conductive material.

9. The preparation method of the graphene composite conductive material of claim 8, wherein in S2, the usage ratio of the MnO₂/graphene composite material to DMF is 1 g:20-30 mL.

10. The preparation method of the graphene composite conductive material of claim 8, wherein the thermal molding process involving heating the mold from room temperature to 200° C. at a rate of 10° C./min, then maintaining the temperature and pressure at 20 MPa for 10 minutes, with multiple depressurization and venting cycles during the process; increasing the temperature to 300° C., and maintaining the temperature and pressure for 40 minutes; after the temperature and pressure holding is completed, the mold is cooled to room temperature and demolded; the sample is then placed in an oven and heated freely to 200° C., held for 60 minutes, then heated to 220° C. and held for 120 minutes; finally, the oven is cooled to room temperature, and then the sample can be taken out.
